(19) United States
(12) Patent Application Publication
(10) Pub. No.: US 2011/0135189 A1
(43) Pub. Date: Jun. 9, 2011

(54) SWARM INTELLIGENCE-BASED MOBILE ROBOT, METHOD FOR CONTROLLING THE SAME, AND SURVEILLANCE ROBOT SYSTEM

(75) Inventor: Chang Eun LEE, Daejeon (KR)

(73) Assignee: Electronics and Telecommunications Research Institute, Daejeon (KR)

(21) Appl. No.: 12/873,569

(22) Filed: Sep. 1, 2010

(30) Foreign Application Priority Data
Dec. 9, 2009 (KR) 10-2009-0121614

(51) Int. Cl. G06T 7/00; B25J 9/18

(52) U.S. Cl. 382/153; 700/248; 901/1; 901/47

(57) ABSTRACT

A plurality of swarm intelligence-based mobile robots, each having multiple legs and multiple joints, the mobile robot includes: an environment recognition sensor for collecting sensed data about the surrounding environment of the mobile robot; a communication unit for performing communication with a remote controller, a parent robot managing at least one mobile robot, or the other mobile robots located within a predefined area; and a control unit for controlling the motions of the multiple legs and multiple joints to control movement of the mobile robot to a given destination based on control data transmitted from the remote controller through the communication unit or based on communication with the other mobile robots within the predefined area or based on the sensed data collected by the environment recognition sensor.

### CROSS-REFERENCE(S) TO RELATED APPLICATION(S)

The present invention claims priority of Korean Patent Application No. 10-2009-0121614, filed on Dec. 9, 2009, which is incorporated herein by reference.

### FIELD OF THE INVENTION

The present invention relates to a robot system, and more particularly, to a swarm intelligence-based mobile robot, a method for controlling the same, and a surveillance robot system having multiple small child robots and parent robots.

### BACKGROUND OF THE INVENTION

FIG. 1 is a view showing a general configuration of a two-wheel drive surveillance robot system of a related art.

As shown in FIG. 1, two-wheel drive surveillance robot includes a driving unit 100, a camera hoisting unit 110, a camera angle adjustment unit 120, and a signal transmission/reception unit 130. The driving unit 100 includes two-wheel drive wheels 101 and an auxiliary wheel 102, each having its own drive means. The camera hoisting unit 110 is mounted on top of the driving unit 100 and uses a lead screw to control the height of a camera. The camera angle adjustment unit 120 is mounted at the top end of the camera hoisting unit 110 and adapted to rotate the camera up and down. The signal transmission/reception unit 130 receives operation commands sent wirelessly through a remote controller (not shown) from a user, and transfers the operation commands to the driving unit 100, the camera hoisting unit 110, and the camera angle adjustment unit 120 to operate them. Further, the signal transmission/reception unit 130 sends image information collected by the camera to the user.

When a driving command is received by the signal transmission/reception unit 130, the driving unit 100 operates to perform driving. In particular, forward and backward motions are performed by rotating the servo motors (not shown) mounted at each of the drive wheels 101 with the same number of revolutions so that both of the drive wheels 101 move constantly in one direction. A direction change such as left and right turns is made by a difference in the number of revolutions by rotating each of the servo motors with the different number of revolutions. Otherwise, the servo motors are set to rotate in opposite directions to each other, that is, the right servo motor is set to rotate in a forward direction and the left servo motor is set to rotate in a backward direction, so that the traveling directions of the two drive wheels 101 are made to be opposite to each other, thus making a quick direction change. While driving, multiple sensors 103 can detect obstacles standing in the traveling direction to prevent an accidental contact or the like. With this feature, the robot system is installed in a specific space to perform surveillance.

Such a robot system provides an economical surveillance robot which facilitates maintenance and repair by simply configuring the driving unit 100 in two wheel drive type and securing a view of the robot in an easy manner. However, the robot system is disadvantageous in that it is not suitable for driving in atypical environments, such as terror attack sites, fire sites, and the like, and cannot correctly recognize a situation because there is no environment detection sensor.

### SUMMARY OF THE INVENTION

In view of the above, the present invention provides a swarm intelligence-based mobile robot, which moves under control of the motions of its multiple legs and multiple joints based on control data transmitted from a remote controller, or controls movement to a destination through communication with neighboring robots using swarm intelligence, and a method for controlling the same.

Further, the present invention provides a small multi-agent surveillance robot system based on swarm intelligence, which is freely movable in atypical environments, and performs surveillance and guard tasks in cooperation with one another on the basis of an active, collective operating system.

In accordance with a first aspect of the present invention, there is provided a plurality of swarm intelligence-based mobile robots, each having multiple legs and multiple joints, the mobile robot including:

an environment recognition sensor for collecting sensed data about the surrounding environment of the mobile robot;

a communication unit for performing communication with a remote controller, a parent robot managing at least one mobile robot, or the other mobile robots located within a predefined area; and

a control unit for controlling the motions of the multiple legs and multiple joints to control movement of the mobile robot to a given destination based on control data transmitted from the remote controller through the communication unit or based on communication with the other mobile robots within the predefined area or based on the sensed data collected by the environment recognition sensor.

In accordance with a second aspect of the present invention, there is provided a method for controlling multiple swarm intelligence-based mobile robots having multiple legs and multiple joints, the method including:

selecting at least one of the mobile robots;

performing communication with the selected mobile robot;

moving the selected mobile robot through the communication and collecting sensed data and/or image data about the surrounding environment of the selected mobile robot; and

controlling movement of the selected mobile robot based on the sensed data and/or image data,

wherein the remaining mobile robots are set to be at an autonomous driving mode and travel through communication with their neighboring mobile robots or through recognition of their surroundings based on the sensed data and/or image data.

In accordance with a third aspect of the present invention, there is provided a swarm intelligence-based surveillance robot system, the robot system including:

multiple child robots having multiple legs and multiple joints;

a remote controller for selectively controlling the multiple child robots and receiving surrounding environment information or image information from the controlled child robots; and

a parent robot for performing a relay function between the remote controller and the multiple child robots.

### BRIEF DESCRIPTION OF THE DRAWINGS

The objects and features of the present invention will become apparent from the following description of embodiments, given in conjunction with the accompanying drawings, in which:

FIG. 1 is a view showing the configuration of a two wheel drive surveillance robot system of a related art;

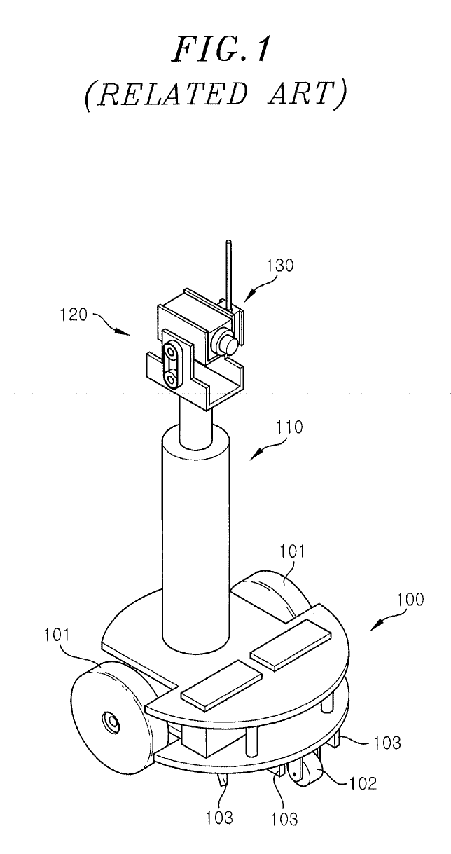

FIG. 2 is a view showing the configuration of a small multi-agent surveillance robot system based on swarm intelligence in accordance with an embodiment of the present invention;

FIG. 3 is a view showing a child robot in accordance with the embodiment of the present invention;

FIG. 4 is a view showing an operation mode of the multi-agent surveillance robot system in accordance with the embodiment of the present invention;

FIG. 5 is a view showing a parent robot in accordance with the embodiment of the present invention;

FIG. 6 is a flowchart showing an operation process of a remote controller in accordance with the embodiment of the present invention;

FIG. 7 is a view showing a process for applying the small multi-agent surveillance robot system based on swarm intelligence in accordance with the present invention to an actual site;

FIG. 8 is a view for explaining a method for operating control of the small multi-agent surveillance robot system based on swarm intelligence in accordance with the embodiment of the present invention;

FIG. 9 is a view showing a procedure for operation and task allocation of the small multi-agent surveillance robot system based on swarm intelligence in accordance with the embodiment of the present invention; and

FIG. 10 is a flowchart showing a process of autonomously creating swam intelligence for an optimum surveillance and guard method in accordance with the embodiment of the present invention.

### DETAILED DESCRIPTION OF THE EMBODIMENT

Hereinafter, embodiments of the present invention will be described in detail with reference to the accompanying drawings which form a part hereof.

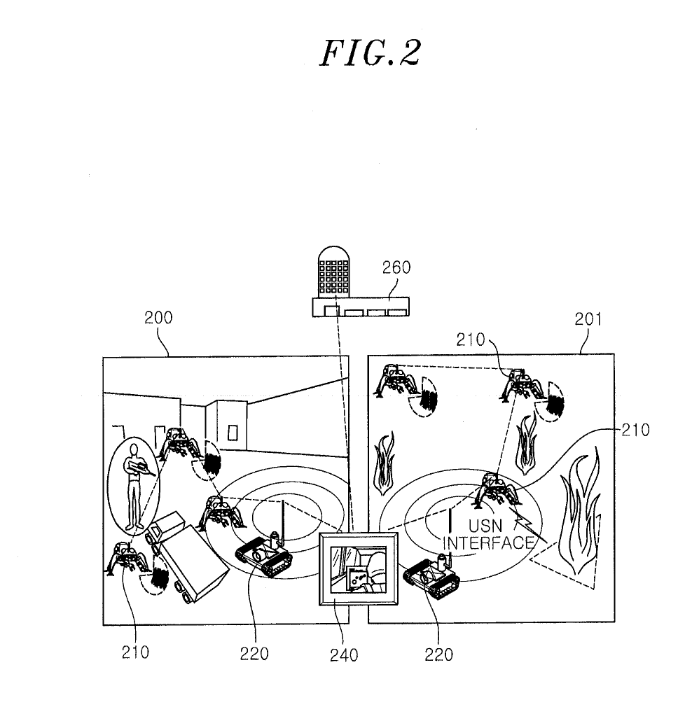

FIG. 2 is a view showing a configuration of a small multi-agent surveillance robot system based on swarm intelligence in accordance with an embodiment of the present invention.

Referring to FIG. 2, the surveillance robot system includes a remote controller 240 such as a portable terminal, a remote control station 260, and at least one group of robots composed of multiple small child robots 210 and wheel-based small/medium parent robot 220. Each of the multiple small child robots 210 has multiple legs and multiple joints and incorporates environment recognition sensors therein. The small/medium parent robot 220 collects information through communication with the multiple small child robots 210 and controls the multiple small child robots 210 remote controller.

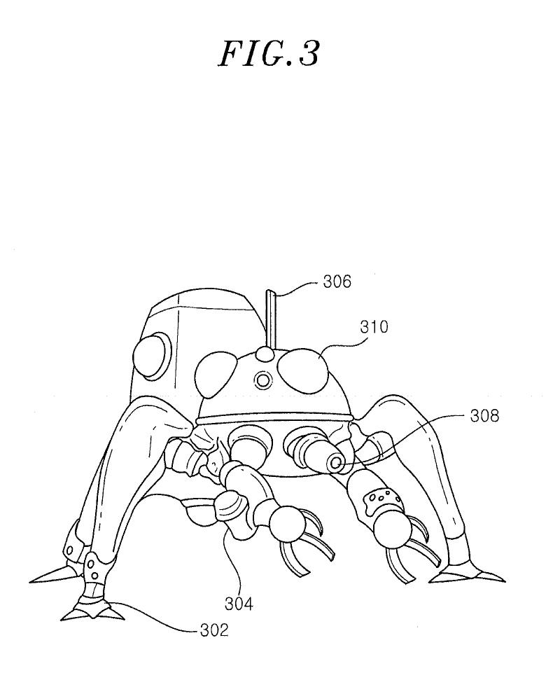

As shown in FIG. 3, the small child robot 210 is a small multi-agent platform, and has multiple legs and multiple joints 302 so as to be freely movable even in atypical environments such as staircases, dangerous areas, and the like. The small child robot 210 includes an environment recognition sensor 304 for collecting sensed data (situation information) to recognize the situation in extreme environments such as terror attack site 200 and fire site 201. The small child robot 210 further includes a communication unit 306, an image pickup unit 308, and a control unit 310.

The small child robot 210 performs, by means of the communication unit 306, communication with the multiple parent robots 220, the remote control station 260, the remote controller 240, or the other child robots 210 within a predefined area, e.g., the terror attack site 200 or the fire site 201. Through such communication, the small child robot 210 provides the data sensed by the environment recognition sensor 304 to the multiple parent robots 220, the remote control station 260, or the other child robots 210 within the predefined area, or receives control data, for controlling the motion of itself, from the parent robot 220, the remote control station 260, or the other child robots 210 within the predefined area.

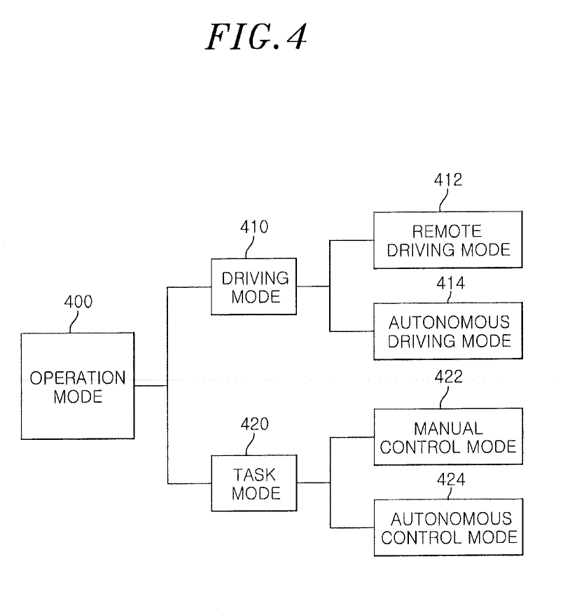

The motion of the small child robot 210 is controlled by the control unit 310. An operation mode of the control unit 310 for controlling the motion of the small child robot 210 is described in FIG. 4. As shown in FIG. 4, an operation mode 400 of the control unit 310 includes driving mode 410 and a task mode 420.

The driving mode 410 includes a remote driving mode 412 and an autonomous driving mode 414. The remote driving mode 412 is controlled by the remote controller 240. In the remote driving mode 412, sensed data collected by the environment recognition sensor 304 of the child robot 210 or image data picked up by the image pickup unit 308 thereof is provided to the remote controller 240. In response to the provided data, control data is received to control the motion of the child robot 210. That is, in the case of the remote driving mode 412, the control unit 310 transmits image data of surroundings picked up by the image pickup unit 308 or data sensed by the environment recognition sensor 304 to the remote controller 240, and thereafter, receives the control data as a response. Based on the received control data, the motions of the multiple legs and multiple joints 302 are controlled to move the child robot 210.

In the autonomous driving mode 414, a route is created based on swarm intelligence, and the child robot 210 moves to a preset destination, while avoiding obstacles, at a speed suitable for a given environment, i.e., surroundings recognized based on the data sensed by the environment recognition sensor 304.

In more detail, the control unit 310 of the child robot 210 controls movement to a preset destination through swarm intelligence, i.e., through communication with the other child robots 210 in the same group, or recognizes surroundings based on the sensed data collected by the environment recognition sensor 304 and then controls motions of the multiple legs and multiple joints 302 depending on the surroundings to move the child robot 210.

Further, the control unit 310 controls the motions of the multiple legs and multiple joints 302 of the child robot 210 so as to maintain a preset distance from its neighboring child robots 210 through communication with the neighboring child robots 210 by the communication unit 306.

The task mode 420 is constituted of manual control mode 422 and autonomous control mode 424. In the manual control mode 422, an operator may directly control the child robot 210 based on the sensed data (situation information) and image data received through the remote controller 240. In this case, the control unit 310 of the child robot 210 transmits the sensed data and/or the image data to the remote controller 240, and then controls the motion of the child robot 210 using control data received as a response.

In the autonomous control mode 424, each of the child robots 210 performs surveillance and guarding on a control area in cooperation with one another while maintaining a preset distance from one another. In this case, the control unit 310 controls the motion of its own child robot 210 based on the data received from the neighboring child robots 210.

Although it has been described with respect to the autonomous control mode 424 and the autonomous driving mode 414 in the embodiment of the present invention that the child robot 210 travels based on communication with the other child robots 210 or along a preset route and performs surveillance and guarding depending on situation information of surroundings of the traveling route, it may also possible that the child robot 210 receives data required for the autonomous control mode 424 and the autonomous driving mode 414 from the remote controller 240 and performs surveillance and guarding based on the received data.

Meanwhile, the small child robots 210 can provide image data of the surrounding environment, picked up by the image pickup unit 308, to the parent robot 220, the remote control station 260, or the other small child robots 210 within predefined area.

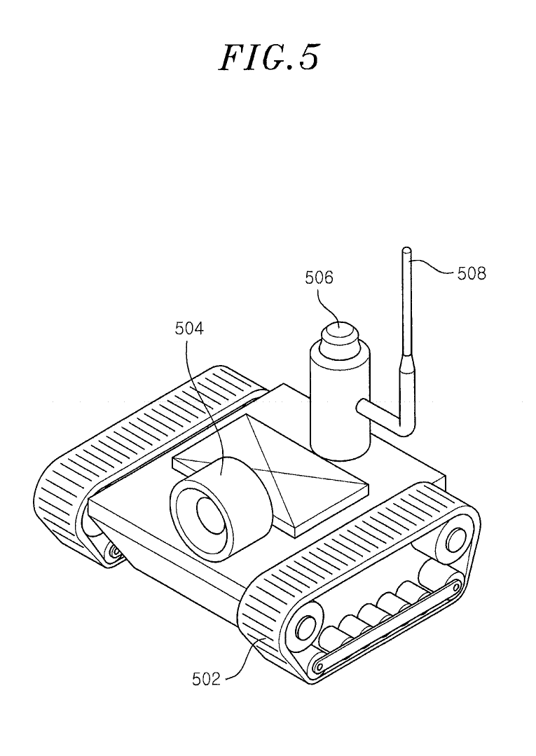

The parent robot 220 is a wheel-based multi-agent platform that serves as a medium for collecting information from the child robots 210 to transfer it to the remote controller 240. The parent robot 220 acts as a group leader dynamically controlling the child robots 210 in one group. In addition, the parent robot 220 relays data exchange between the remote controller 240 and the child robots 210 getting out of a wireless cell boundary, which is a communication range of the remote controller 240, or entering a shadow area. To this end, as shown in FIG. 5, the parent robot 220 includes wheels 502, a camera 504, a GPS processor 506, and a short distance communication unit 508.

The above-described multiple small child robots 210 and the multiple parent robots 220 as mobile robots can acquire situation information about the surrounding environment in conjunction with a ubiquitous sensor network (USN).

The remote controller 240 is connected to the parent robots 220 or the child robots 210 based on WiFi and/or WiBro, and provides real-time robot operation information processing and image information processing which are required to operate a platform of multiple small mobile robots on the spot. As an example of the remote controller 240, there may be a portable C4I (Command, Control, Communications, Computers, and Intelligence) terminal.

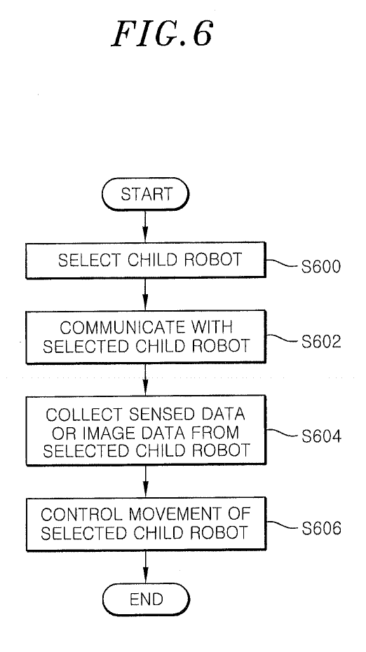

A process in which the remote controller 240 operates each robot group composed of multiple child robots and one parent robot 220 will be described in detail with reference to FIG. 6.

Referring to FIG. 6, an operator selects at least one child robot 210 through an interface provided by the remote controller 240 in step 5600. The selected child robot 210 is controlled at the manual control mode 422 and the remote driving mode 412.

Next, the remote controller 240 performs communication with the selected child robot 210 in step 5602. Through such communication, sensed data and/or image data about the surrounding environment of the selected child robot 210 is collected from the selected child robot 210 in step 5604. The collected sensed data and/or image data is provided to the operator through the remote controller 240.

Then, the operator can recognize surrounding situation information based on the collected sensed data and/or image data displayed on the remote controller 240. The remote controller 240 generates control data for controlling the movement of the selected child robot 210 depending on the operator's manipulation and transmits the control data to the selected child robot 210 and the parent robot 220, thereby controlling the movement of the selected child robot 210 and the parent robot 220 in step 5606.

In the meantime, unselected child robots 210 and parent robots 220 are set to be at the autonomous control mode 424 and autonomous driving mode 414 and travel through communication with the other child robots in the same robot group or through recognition of their surroundings based on the sensed data and/or image data. The remote control station 260 remotely manages the status of multiple remote controllers 240 via a WiBro network, and notifies all the remote controllers 240 of situation information of other areas using a text messaging function, that is, SMS transmission function.

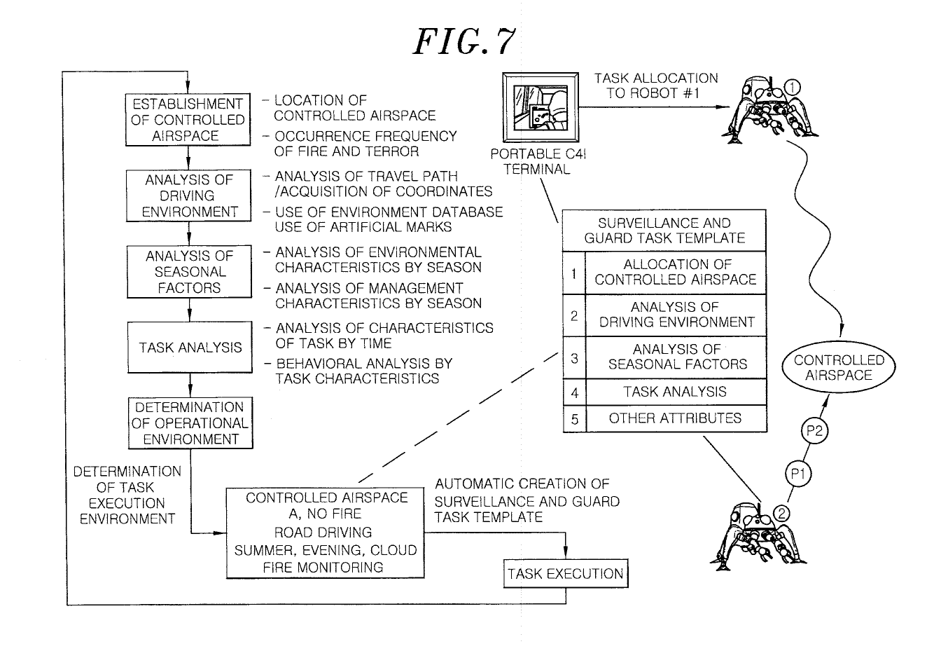

A process for applying the small multi-agent surveillance robot system based on swarm intelligence having the above configuration to an actual site will be described in detail with reference to FIG. 7.

FIG. 7 is a view showing the process for applying the small multi-agent surveillance robot system based on swarm intelligence in accordance with the present invention to an actual site. To apply the surveillance robot system, first, it is required to take a preliminary survey of the location and extent of an area or airspace where a fire or terror attack took place, the frequency of fires or terror attacks, and the like. Based on results of the preliminary survey, an actual surveillance robot determines a driving environment for executing its task and analyzes it. At this time, GSP coordinates of the travel path are acquired, an environment map of obstacles is created, and artificial marks required for autonomous driving are set. Since the driving environment has to be determined especially considering seasonal factors, a procedure for collecting information about seasonal environment conditions, road conditions, and the like is required. When analysis of the seasonal factors is completed, the features of the task depending on time, weather, and the like, at which the task is to be done, are analyzed, thereby finally determining an operational environment.

The operational environment for executing the task determined through the above-described procedure derives a surveillance and guard task template reflecting the features of the task in relation to controlled airspace, traveling environment, season, and situation. Using this control task template, determination is made as to how individual robots move, how the distance between the robots is adjusted, and time intervals at which the robots are arranged, and the determined results are transferred to the robots. By this method, even when the robots move to the same area, the robots may have different movement patterns. Thus, various situation information of a fire or terror attack site can be obtained based on random behavior patterns of the moving robots.

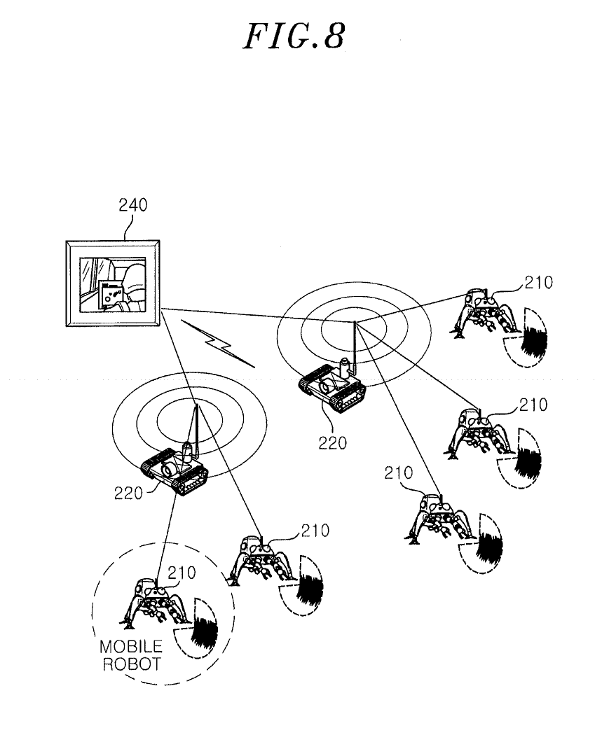

FIG. 8 is a view for explaining the process for operating control of the small multi-agent surveillance robot system based on swarm intelligence in accordance with the embodiment of the present invention.

Referring to FIG. 8, the operator of the remote controller 240 selects at least one of the multiple mobile robot platforms, i.e., of the multiple child robots 210, and acquires control thereof to remotely operate the selected mobile robot platform. Further, the operator operates the other child robots 210 in the autonomous driving mode 414 and the autonomous control mode 424. The operator may also acquire control of the other child robots 210 anytime using the remote controller 240.

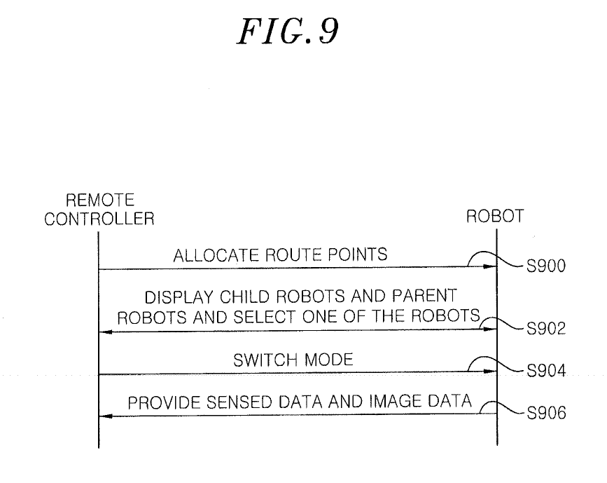

An optimum surveillance and guard process using the surveillance robot system in accordance with the embodiment of the present invention will be described in detail with reference to FIG. 9.

FIG. 9 is a view showing a procedure for operation and task allocation of the small multi-agent surveillance robot system based on swarm intelligence in accordance with the embodiment of the present invention.

As shown in FIG. 9, route points are allocated to the multiple child robots 210 and parent robots 220 through the remote controller 240 of the operator in step S900. The route points are provided directly to the child robots 210 and the parent robots 220 through the remote controller 240, or provided to the child robots 210 using relay function of the parent robot 220.

Next, the operator displays images of the child robots 210 and the parent robots 220 on an image display (not shown) of the remote controller 240, and selects one of them in step S902.

Subsequently, the remote controller 240 acquires control of the selected child robot 210 and switches to the remote driving mode 412 using remote control in step S904. Information, provided from the child robots 210 and parent robots 220 within the mobile robot platform remotely controlled at the remote driving mode 412, e.g., position information, sensed data, image data, and the like are displayed on the remote controller 240 in step S906.

In a driving operation procedure for the child robots 210 and the parent robots 220, the robots move to a specific point in the autonomous driving mode 414 after applying power to the robots, and are switched to the remote driving mode 412 as the routing points are allocated. Further, the robots move to target points in the remote driving mode 412 by the operator of the remote controller 240. By operating the task equipment after stopping between movements, surveillance and guard activities are carried out.

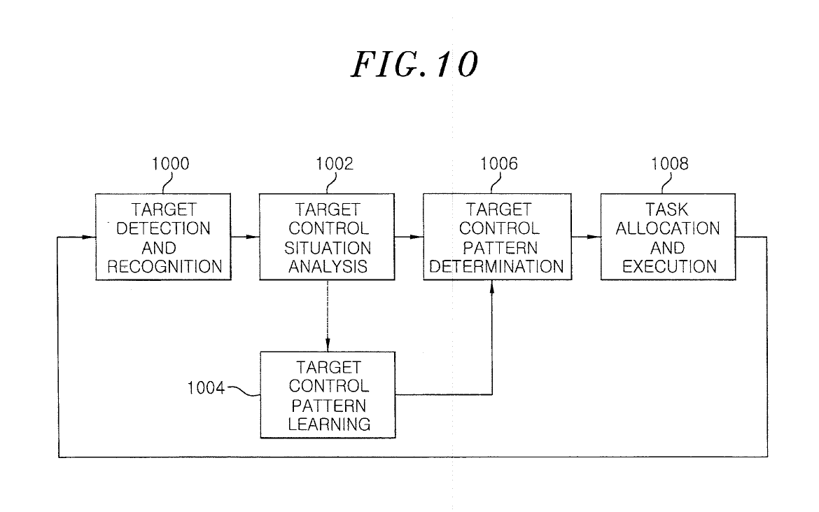

FIG. 10 is a flowchart showing a process of autonomously creating swam intelligence for an optimum surveillance and guard method in accordance with the embodiment of the present invention.

Referring to FIG. 10, the method for autonomously creating swam intelligence includes a target detection and recognition step 1000 for figuring out the presence/absence, number, type, and the like of a target, a target control situation analysis step 1002 for analyzing the surrounding situation of the recognized target, a target control pattern learning step 1004 for autonomously creating target control patterns based on the analyzed situation, a target control pattern determination step 1006 for determining an optimum control pattern appropriate for the situation among the created target control patterns, and a task allocation and execution step 1008 for allocating the determined optimum control pattern onto a mobile robot platform and executing the task.

As described above, the present invention can move robots under control of the motions of their multiple legs and multiple joints based on control data transmitted from a remote controller, or control movement to a destination through communication with surrounding robots using swarm intelligence, thereby allowing the robots to be freely movable in atypical environments and to perform surveillance and guard tasks in cooperation with one another on the basis of an active, collective operating system.

While the invention has been shown and described with respect to the embodiments, it will be understood by those skilled in the art that various changes and modification may be made without departing from the scope of the invention as defined in the following claims.

What is claimed is:

1. A plurality of swarm intelligence-based mobile robots, each having multiple legs and multiple joints, the mobile robot comprising:
an environment recognition sensor for collecting sensed data about the surrounding environment of the mobile robot;
a communication unit for performing communication with a remote controller, a parent robot managing at least one mobile robot, or the other mobile robots located within a predefined area; and
a control unit for controlling the motions of the multiple legs and multiple joints to control movement of the mobile robot to a given destination based on control data transmitted from the remote controller through the communication unit or based on communication with the other mobile robots within the predefined area or based on the sensed data collected by the environment recognition sensor.

2. The mobile robot of claim 1, further comprising an image pickup unit for picking up the surrounding environment of the mobile robot to create image data.

3. The mobile robot of claim 2, wherein the control unit transmits the sensed data and the image data to the remote controller, and receives the control data in response to the sensing data and the image data.

4. The mobile robot of claim 1, wherein the control unit transmits the sensed data to the remote controller, and thereafter receives the control data in response to the sensed data.

5. The mobile robot of claim 1, wherein the control unit controls the movement of the mobile robot while maintaining a preset distance from its neighboring mobile robots through communication with the neighboring mobile robots.

6. The mobile robot of claim 1, wherein, when the mobile robot gets out of a communication range of the remote controller, or enters a shadow area remote controller while communicating with the remote controller through the communication unit, the control unit performs communication with the remote controller via the parent robot located within the defined area.

7. The mobile robot of claim 1, wherein the mobile robot acquires situation information about the surrounding environment in conjunction with a ubiquitous sensor network.

8. A method for controlling multiple swarm intelligence-based mobile robots having multiple legs and multiple joints, the method comprising:
selecting at least one of the mobile robots;
performing communication with the selected mobile robot;
moving the selected mobile robot through the communication and collecting sensed data and/or image data about the surrounding environment of the selected mobile robot; and
controlling movement of the selected mobile robot based on the sensed data and/or image data,
wherein the remaining mobile robots are set to be at an autonomous driving mode and travel through communication with their neighboring mobile robots or through recognition of their surroundings based on the sensed data and/or image data.

9. The method of claim 8, wherein, when the selected mobile robot gets out of a communication range of a remote controller or enters a shadow area, the communication with the selected mobile robot is performed via a parent robot managing the selected mobile robot.

10. The method of claim 8, wherein said controlling movement of the selected mobile robot includes:
analyzing obstacle information and/or surrounding situation information based on the sensed data and/or the image data; and
controlling the movement of the selected mobile robot based on the analyzed obstacle information and/or surrounding situation information.

11. The method of claim 10, wherein the surrounding situation information is transmitted to other remote controller via a remote control station connected to the remote controller.

12. The method of claim 11, wherein the surrounding situation information is transmitted to the other remote controller using a text messaging function of the remote control station.

13. A swarm intelligence-based surveillance robot system, the robot system comprising:
multiple child robots having multiple legs and multiple joints;
a remote controller for selectively controlling the multiple child robots and receiving surrounding environment information or image information from the controlled child robots; and
a parent robot for performing a relay function between the remote controller and the multiple child robots.

14. The robot system of claim 13, wherein an operator of the remote controller selects at least one of the multiple child robots through an interface provided by the remote controller to remotely and manually control the selected child robot, and allows unselected child robots to autonomously move and control themselves.

15. The robot system of claim 14, wherein the unselected child robots that autonomously move and control themselves move to a preset destination, while avoiding obstacles, at a speed which is determined by finding out surrounding situation information using an environment recognition sensor embedded therein.

16. The robot system of claim 14, wherein the unselected child robots that autonomously move and control themselves perform movement by communicating with the selected child robot that is remotely and manually controlled.

17. The robot system of claim 14, wherein the selected child robot that is remotely and manually controlled is controlled by transmitting sensed data collected by an environment recognition sensor or image data picked up by an image pickup unit to the remote controller and then receiving control data as a response.

18. The robot system of claim 13, wherein, when the selected child robot that is remotely and manually controlled gets out of a communication range of the remote controller or enters a shadow area, the selected child robot communicates with the remote controller via the parent robot managing the selected child robot that is remotely and manually controlled.

19. The robot system of claim 14, wherein the remote controller transmits data required for the autonomous driving and autonomous control to the unselected child robots to thereby allow the unselected child robots to autonomously control themselves.

20. The robot system of claim 19, wherein the data required for the autonomous movement and autonomous control is created by recognizing presence/absence, number and type of a target on an area to which the child robots move, analyzing the surrounding situation of the recognized target, autonomously creating target control patterns based on the analyzed surrounding situation, determining an optimum control pattern appropriate for the situation among the created target control patterns, and using the determined optimum control pattern.
